(19) United States
(12) Patent Application Publication
(10) Pub. No.: US 2007/0130143 A1
(43) Pub. Date: Jun. 7, 2007

(54) System and Method for File Sharing and Collaboration on the Internet

(76) Inventors: Wenbing Zhang, San Jose, CA (US); Xianke Huang, Shanghai (CN)

Correspondence Address: SQUIRE, SANDERS & DEMPSEY L.L.P, PATENT DEPARTMENT, ONE MARITIME PLAZA, SUITE 300, SAN FRANCISCO, CA, 94111-3492, US

(21) Appl. No.: 11/424,240

(22) Filed: Jun. 15, 2006

Related U.S. Application Data
(60) Provisional application No. 60/742,804, filed on Dec. 5, 2005.

(51) Int. Cl. G06F 17/30

(52) U.S. Cl. 707/8

(57) ABSTRACT

Embodiments of the invention enable a self-registered user to store files and/or folders on a web server system, each file and/or folder having different share levels for other self-registered users. The other users can then access each file and/or folder based on their respective share levels after logging in to their accounts.

### PRIORITY REFERENCE TO PRIOR APPLICATION

This application claims benefit of and incorporates by reference patent application Ser. No. 60/742,804, entitled “FILE SHARING SYSTEMS AND METHODS,” filed on Dec. 5, 2005, by inventors Wenbing ZHANG et al.

### TECHNICAL FIELD

This invention relates generally to file sharing and access on the Internet, and more particularly, but not exclusively, provides a system and method for enabling file sharing at a plurality of access levels set by a user on the Internet.

### BACKGROUND

In conventional networks, such as a Microsoft Windows-based local network, one can share folders to different users with different permissions. This works well when: the number of users is limited (<10000); the system administrator knows all the users and he creates all the accounts; and sharing is within a company/organization. The same method doesn't work on the Internet when the users are “unlimited or unknown” and “self-registered” (vs. limited or known, created by an administrator). Other conventional file-sharing methods such as email and FTP are not optimized for Internet users either due to the limited sharing functionality or due to the account administration requirements.

Many Internet storage websites offer file-sharing service. They use one or all of the following methods:
Share a file/folder by emailing a special URL;
Share a folder/file by displaying a webpage and prompt for a password (or called access key, code, etc.), in which case, files or folders can be read-only or read-write;
Share a folder/file with no password, usually read-only in this case;
Use a special folder for sharing and exchange files;

The shared file access method is also limited to “using a web browser”, which is very hard to download shared files, especially when the shared files are very large, or there are many files to download. Users can only download files one by one from a web browser.

“Special URL” based sharing is not secure when one only wants to share with a few people. The problem is once the file/folder is shared, one cannot change the URL; if one does, the file is no longer accessible at the original URL—thus other people cannot access it any more; but if one doesn't change the URL, when the URL is leaked, anybody can access the file. Using a special folder for sharing is very inflexible. Moreover, one can only have one type of access privilege for the special folder. Using a share password is also insecure and inflexible: again, if one changes the share password, others won't be able to access the files anymore; but if one doesn't change the password, the password could leak out eventually.

As such, a new system and method is needed that offers improved functionality of sharing files and folders over the Internet, matching similar functionality that's only available on local network with Windows-based file-sharing.

### SUMMARY

Embodiments of the invention enable users to share documents on the Internet to different people with different permissions; files can be accessed from a web browser, or from client software with an extremely easy-to-use user interface. More importantly, the technology:
Is compatible with all firewalls.
   It works on the Internet (over HTTP/HTTPS/FTP/WebDAV protocols) and won't be blocked by firewalls;
It supports virtually unlimited number of users.
   It uses a logical file system on the server side, such that the storage is much more scalable than regular physical storage, e.g., a file can appear to be stored in one folder yet there is no such physical folder. The folder info is stored in database only. This way, the folder size can be unlimited, spanning many physical storage systems.

Embodiments differentiate themselves from the conventional technologies in that file/folder permissions can be granted at a very fine level: you can share a folder to different people with different level of permissions (e.g., 7 different permission levels. Other users can log onto their own accounts and access the folder one shared to them. In this case, the share password is not needed. Users can change their passwords and still be able to access the shared folder/file. One can set different permissions for different users. So some users can access the files read-only; some users can upload files to the folder; and some users can delete the files, etc. To access shared files/folders, not only you can use a web browser, embodiments also include client software that enables users to download/upload many shared files very easily. Drag and drop is supported.

Accordingly, users never need to remember any share passwords or access keys/codes, etc. (otherwise, it could be very messy when many people shared many folders to a user and each folder has its own share password). This method can be called User-based Sharing and Permission, where a specific right is granted to a specific user. As long as the user can be authenticated, he/she gains the specific right.

Embodiments also include accessing shared folders by logging on one's own account, and seeing the folders shared to one listed in a Virtual Share Root Folder (, e.g. DriveHQ Share).

One can easily copy files/folders among his own folders and the shared folders; multiple levels of permissions are supported; Shared files are more secure: one never needs to send share passwords/access keys/codes. A user just accesses the shared folders and files using his/her own username and password; and the user can change the password at anytime without affecting his permission to access the shared folders. With advanced client applications, it is much more efficient in sharing and accessing many files.

In an embodiment of the invention, a method comprises: storing a first user's files in memory; the first user shares his files to other users and he/she sets different share levels for other users; the first user being self-registered. They system receives a request from a self-registered user (let's call it OTHER USER) over the Internet for a list of accessible folders and files; determining which of the folders/files are accessible to the self-registered user based on share access levels; and transmitting a list of the determined files/folders to the self-registered user over the Internet. The shared folders are placed in a Virtual Share Root Folder and included in the same folder structure as OTHER USER's folder tree. The sharing can work in two-directions: OTHER USER can also transmit his/her own files to the first user's folder if the first user sets a shared folder with write permission. In addition, OTHER USER can edit files if the shared folder has that share access level. Different users can have different share access levels for the same folder.

In an embodiment of the invention, a computer-readable medium has instructions stored thereon to cause a computer to execute the method

In an embodiment of the invention, a system comprises a file system layer and a UI module. The file system layer is capable of storing a first user's files/folders in memory. The folders/files can be set with different share levels for other users. The System is capable of receiving a request from a self-registered user over the Internet for a list of accessible folders/files, and capable of determining which of the folders/files are accessible to the self-registered user based on share levels, and capable of transmitting a list of the determined files to the self-registered user over the Internet, and if the self-registered user is granted with write permission to a shared folder of the first user, it is capable of transmitting the self-registered user's files to the first user's folder.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating a network system in accordance with an embodiment of the invention;

FIG. 2 is a block diagram illustrating a file sharing system of the network system of FIG. 1;

FIG. 3 is a block illustrating a file sharing system according to another embodiment of the invention;

FIG. 4 is a block diagram illustrating a memory of the file sharing system and client;

FIG. 5 is a screen shot illustrating a graphical user interface of the file sharing system;

FIG. 6 is a flowchart illustrating a method of signing of sharing folders/files;

FIG. 7 is a flowchart illustrating a method of accessing shared folders/files; and

FIG. 8 is a screen shot illustrating mulit-level sequential storage of files.

### DETAILED DESCRIPTION OF THE ILLUSTRATED EMBODIMENTS

The following description is provided to enable any person having ordinary skill in the art to make and use the invention, and is provided in the context of a particular application and its requirements. Various modifications to the embodiments will be readily apparent to those skilled in the art, and the principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

An embodiment of the invention includes 3 components: a Backend, a Web Front-end Design, and Client Software Applications. The Backend includes a Logical File System Design: Database Schema design; Scalable storage design; and Network architecture design: ensures high reliability and high scalability such that there is no single point of failure.

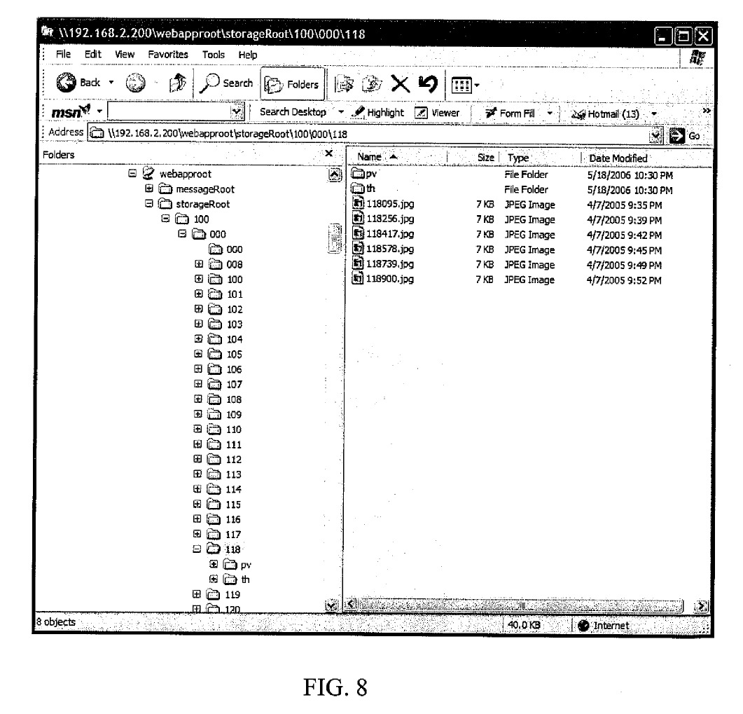

The main tables in database include Customers, Files, Folders, Shares, ShareDetails and Permissions. File and folder info is stored in relational database for quick indexing and querying, etc. File data are saved as physical files on the physical storage; this makes it easier in physical file management/backup; and the system is much more scalable than storing the file data in Database. (There are no physical folders corresponding to DriveHQ folders. All DriveHQ folders are “virtual folders”, the folder info is only available in database.) The physical storage is organized in a multi-level sequential way, as shown in FIG. 8. This makes the system more scalable and secure as a user's file could spread around anywhere; so that a targeted attack to a particular user account is much harder than if all user files are stored in a physical folder.

The Web Front end design includes a web user interface that makes the technology and features easily available to end users. Users can store their files in a Root folder and subfolders; they can select a folder and click on Share in the toolbar section. Users can enter a share name, description, select a permission level and optionally enter a share password; then enter/choose the share-to users.

The client software is very easy to use and will be discussed in further detail below.

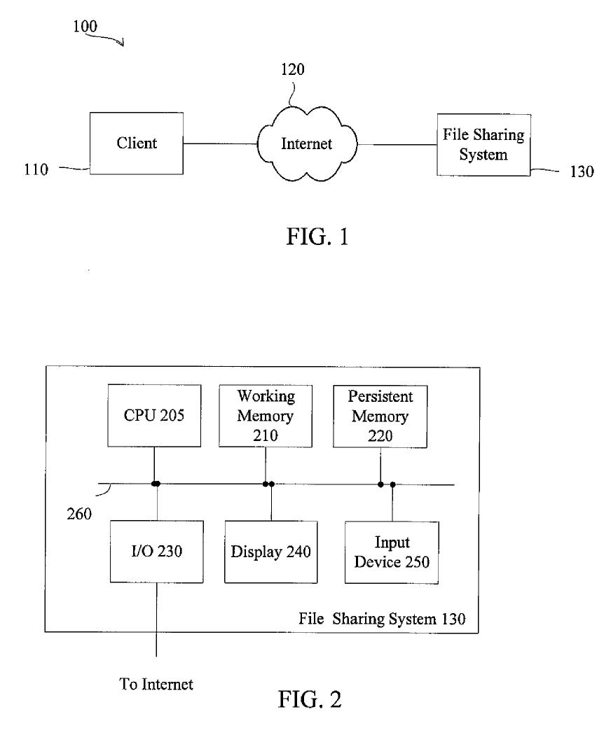

FIG. 1 is a block diagram illustrating a network system 100 in accordance with an embodiment of the invention. The network system 100 includes a client 110, a network 120, such as the Internet, and a file sharing system 130. The file sharing system 130 and client 110 are interconnected via the Internet 120. In an embodiment of the invention, the network system 100 can have additional nodes, such as a plurality of clients 110 that communicate with the file sharing system 130. The client 110 and/or file sharing system 130 may be implemented on various devices, such as personal digital assistants, wireless phones, laptop computers, desktops, servers, etc., as long as the client 110 and/or system 130 is capable of communicating with the network 120.

During operation of the network system 100, the client 110 accesses files/folders stored on the file sharing system 130. The files/folders can be a user's own files or other files/folders that a second user granted access to. A user can also set different access levels for others for his/her files/folders. These access levels include but are not limited to: Thumbnail Access, Preview Access, Original File Download, View Comments and Ratings, Comment and Rate, Upload/Add, Edit/Modify, Delete, Full Access, etc.

FIG. 2 is a block diagram illustrating the file sharing system 130 of the network system 100. The file sharing system 130 includes a central processing unit (CPU) 205; working memory 210; persistent memory 220; input/output (I/O) interface 230; display 240; and input device 250, all communicatively coupled to each other via a bus 260. The CPU 205 may include an INTEL PENTIUM microprocessor, a Motorola POWERPC microprocessor, or any other processor capable to execute software stored in the persistent memory 220. The working memory 210 may include random access memory (RAM) or any other type of read/write memory devices or combination of memory devices. The persistent memory 220 may include a hard drive, read only memory (ROM) or any other type of memory device or combination of memory devices that can retain data after the file sharing system 130 is shut off. The I/O interface 230 is communicatively coupled, via wired or wireless techniques, to the network 120. The display 240 may include a flat panel display, cathode ray tube display, or any other display device. The input device 250, which is optional like other components of the invention, may include a keyboard, mouse, or other device for inputting data, or a combination of devices for inputting data.

In an embodiment of the invention, the file sharing system 130 may also include additional devices, such as network connections, additional memory, additional processors, LANs, input/output lines for transferring information across a hardware channel, the Internet or an intranet, etc. One skilled in the art will also recognize that the programs and data may be received by and stored in the file sharing system 130 in alternative ways. Further, in an embodiment of the invention, an ASIC is used in placed of the file sharing system 130.

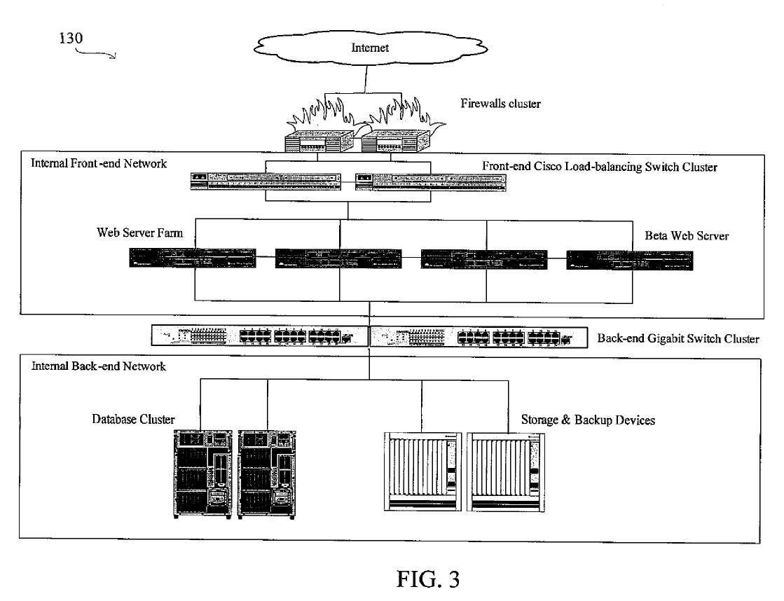

FIG. 3 is a block illustrating a file sharing system 130 according to another embodiment of the invention. The file sharing system 130, in this embodiment, includes a firewall cluster communicatively coupled to the Internet 120. An internal front end network is coupled to the firewall cluster and to a backend gigabit switch cluster, which is coupled to an internal backend network. The internal front end network includes a front end load-balancing switch cluster coupled to a web server farm, which is coupled to the backend gigabit switch cluster. The internal backend network includes a database cluster and storage & backup devices, both of which are coupled to the backend gigabit switch cluster.

The network design focuses on Security, Performance/Scalability and Reliability. It also shows that the solution is a web-based solution; again the key advantages of this system are: (1) It works with all Firewalls and works on the Internet using standard web protocols; (2) It uses RDBMS for user, file, folder, share info; creating a highly scalable user management and logical file system; and (3) It eliminates the need to have a system administrator to create accounts for users. By doing so, the system can support millions of Internet users to share files and collaborate on the Internet with ultimate convenience and security.

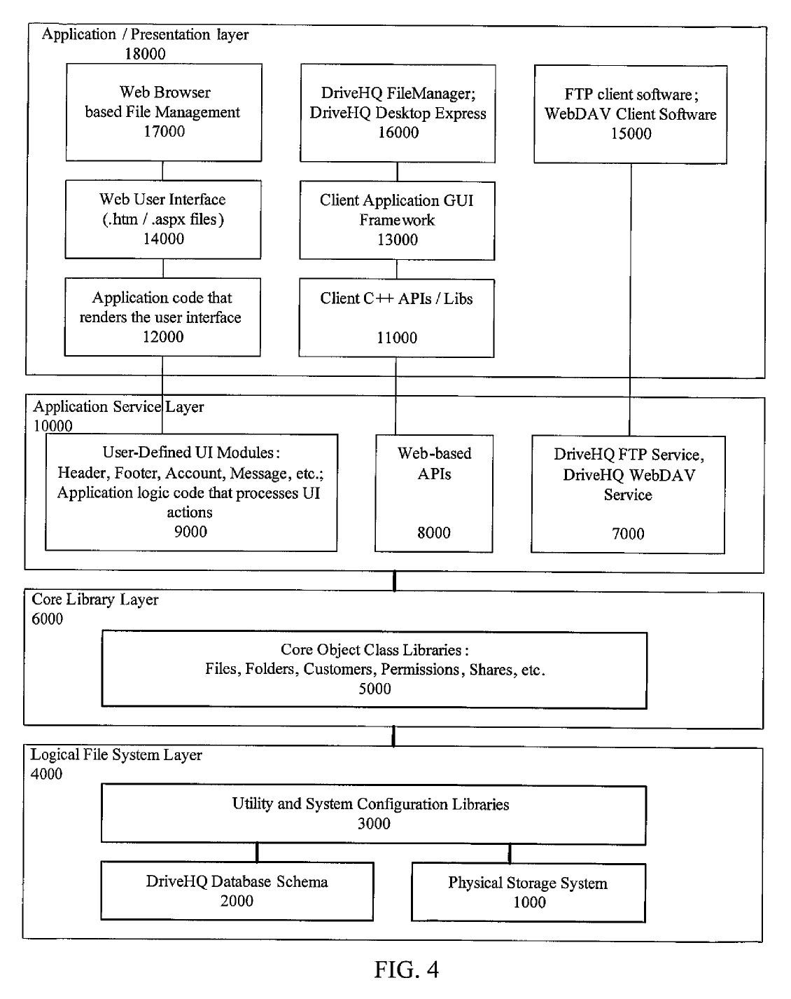

FIG. 4 is a block diagram illustrating a memory 220 of the file sharing system and client. In an embodiment of the invention, the system is designed as a 4-tier application. Each tier (layer) acts “very independently”, hides the complexity of the layer below its layer. There is a logical file system layer 4000 communicatively coupled to a core library layer 6000, which is coupled to an application service layer 10000, which is coupled to an application/presentation layer 18000 via the Internet 120.

The logical file system layer 4000 includes a physical storage system 1000, a Database Schema 2000, utility and system configuration libraries 3000. The physical storage system 100 can be any kind of physical storage device, including Directly Attached Storage (Computer hard disks), Network Attached Storage (NAS), SAN (Storage Area Network) etc.

A folder StorageRoot is the root folder of the physical storage; all users' files are named with FileID.OriginalFileExtension, and placed in a folder which holds a maximum of 1000 files or subfolders. The folder name is numerical.

The StorageRoot folder is changeable as more storage is added to the storage system.

The Database schema 2000 includes a plurality of tables. The main tables in this embodiment include: Files, Folders, Customers, Shares, ShareDetails and Permissions. Where customers table records all user related info; Files and Folders table records files folders info; physical file is stored in 1000. This makes the system more scalable than if we store files in the database schema 2000.

The entire logical folder structure is stored in the database schema 2000; storage quota and download bytes info is also stored in the database schema 2000.

The base utility and configuration libraries 3000 implement the system logic of a logical file system; combined with the physical storage 1000 and the database schema 2000, it becomes 4000: a logical file system, that hides the complexity of the real storage and database design.

The Core Library Layer (600) includes core object class libraries that implement classes such as Files, Folders, Customers, Permissions and Shares, corresponding to the database tables in the “Logical File System Layer”. These classes hide the complexity of managing database tables and physical files, while offering complete file management and sharing functions to the high-level tiers.

The Application Service layer 10000 includes a FTP service and WebDAV service 7000; web-based APIs 8000; and User Defined UI Modules 9000. This layer provides all the services for file management and sharing, allowing a variety of applications to be built on top of the service. DriveHQ FTP service 7000 is the most scalable FTP server in the world, which can support millions of named users (vs. Anonymous users). DriveHQ WebDAV Service 7000 enables users to map DriveHQ storage as a network drive, which can be done by installing DriveHQ WWWDrive client software. Both the FTP and WebDAV services are fully integrated with DriveHQ.com Internet storage sharing system. DriveHQ WWWDrive utilizes Microsoft WebDAV redirector to map a network drive on the client side; on the server-side, it implements WebDAV protocol.

In this embodiment, the Web-Based APIs 8000 include a text/HTML/XML mixed API for best performance. The API allows users to manage storage through HTTP/web interface, e.g., a user can submit an HTTP post with username and password to log on his account. The API will return the logon status, and if logon was successful, it also returns a logon SessionID.

The user-defined UI modules 9000 include application code that handles GUI components (modules), application flow and processes user actions.

The application/presentation layer 18000 includes Client APIs/Libraries; Application code for the UI 12000; Client Application GUI 13000 framework; Web User Interface 14000; FTP client software 15000; FileManager software 16000; and Web Browser base file management software 17000.

The C++APIs/Libs 11000 is the client SDK. The libraries basically wrap the HTTP API into client functions. The client API functions call the HTTP based API; when client software utilizes the API, the library hides the complexity of HTTP communication.

The application code 12000 includes .aspx.cs files, which is also called “code-behind”. The code renders the HTML (.aspx) page, binding the data to the HTML page.

The Application GUI Framework 13000 enables the client application to be easily customizable with professional look and feel and also provides excellent usability and Windows Explorer integration.

The UI 14000 and the Web Browser file management 17000 relate to website page design. They provide a folder tree view design is extremely well designed in a 4-frame architecture outlined below:

Of the 4 frames, a header frame offers consistent navigation tabs and corporate identity only. The other 3 frames are very important in this implementation.
(1) When a user accesses this page, the main HTML page is returned, which defines 4 frames. So the browser sends another 4 requests to get the 4 frame contents.
(2) When the Left Tree Frame is called, the system queries the database to get a list of all folders belong to this user; it also gets a list of folders shared to this user from other users.
(3) The tree node can be expanded without submitting another query to the server;
(4) Shared folders are listed in a special folder called “DriveHQShare” in an embodiment. Inside this special folder are the “virtual folders” that are usernames who shared folders to the current logon user. This makes sharing among multiple users very easy. Users never need to remember share passwords/share keys/codes, etc. And users can change their own password at anytime without affecting the shared folder permission.
(5) When select a subfolder or double click on a subfolder, the 3 frames are synchronized without submitting a new request in the Left Tree Frame;
(6) When a user selects different folders with different permissions, the toolbar buttons change states based on the folder permission. Minimal download is required as the browser only needs to download the HTML file of the toolbar frame, which is a very small download and is extremely efficient.

The FTP client software 15000 includes and FTP software capable of transferring files.

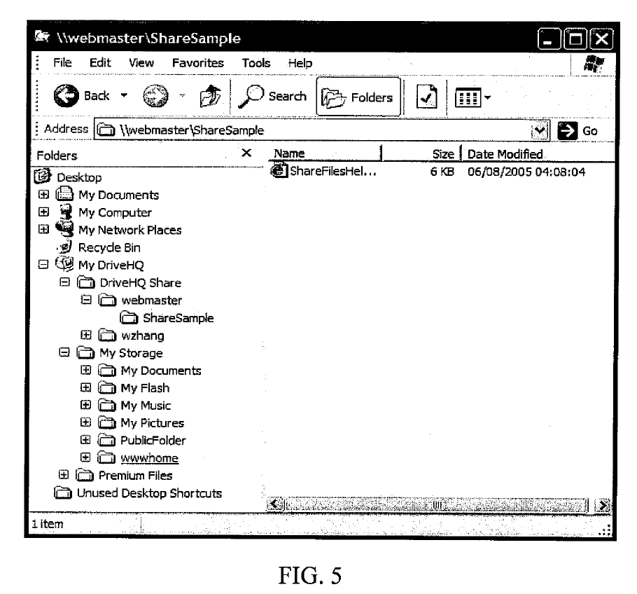

The FileManager and Desktop Express 16000 make storage and sharing extremely easy and they provide an easy, secure and unique sharing method on the Internet, a shown in FIG. 5 in which access to files over the Internet is via the desktop.

In an embodiment, a GUI Interface can be used via the web. On the web, from My Storage, a user clicks on the folder he/she wants to share, and then click on Share in the toolbar. A user then needs to: Enter the share name, a share password (not required) and share description; Select a permission level from the drop-down list; and Enter other persons' usernames or email addresses, or “Add from contacts”; and Click “Apply” to create the Share.

A similar interface is implemented in the FileManager 16000. Under the hood, the system adds a new row in the table Shares. Also it adds multiple entries into another table ShareDetails, which has the following columns: ShareID, ObjID, CustomerID, ObjTypeID, PermissionID, AccessTimes, Status. ShareID associates the entry with a Share; “ObjID, CustomerID, ObjTypeID, PermissionID” is used to represent: Share this Object (represented by ObjID, ObjTypeID) to the user (customerID) with a permission (represented by permissionID).

A relational database is used to store all user, file, folder, share, share detail info. The logical folder structure is also stored in the database. The files are stored in the physical storage device, which can be any kind of storage devices. In an embodiment of the invention Network Attached Storage (NAS) can be used.

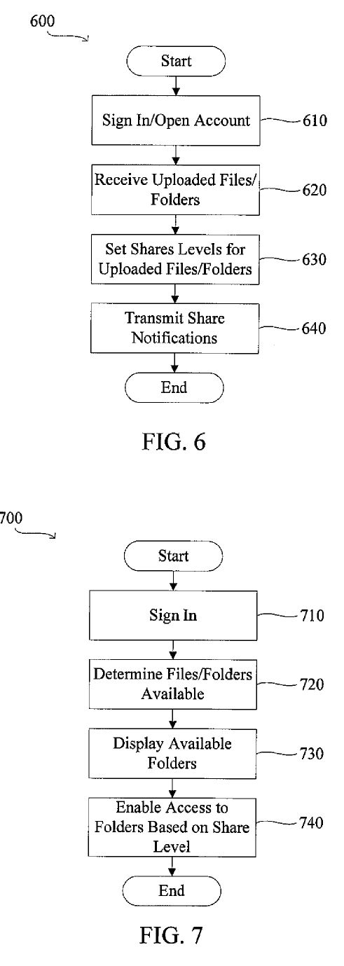

FIG. 6 is a flowchart illustrating a method 600 of signing of sharing folders/files. First, a user either signs in to an existing account or creates a new account (610) by self-registering. The user then transmits files to the system 130, which are received (620). The user then sets share levels (630) for the uploaded files and/or folders. The system 130 then transmits share notifications to others based on the set share levels. The method 600 then ends.

FIG. 7 is a flowchart illustrating a method 700 of accessing shared folders/files. First, user signs in (710). Then the system 130 determines (720) what files/folders are available based on permissions set by a user in method 600. The system 130 then transmits the determination to the client 110, where it is displayed (730). The client 110 then enables (740) access to these files/folders. The method 700 then ends.

In an embodiment of the invention, multiple instances of methods 600 and 700 can be run substantially simultaneously. For example, multiple clients can be running signing in (710).

The foregoing description of the illustrated embodiments of the present invention is by way of example only, and other variations and modifications of the above-described embodiments and methods are possible in light of the foregoing teaching. Although the network sites are being described as separate and distinct sites, one skilled in the art will recognize that these sites may be a part of an integral site, may each include portions of multiple sites, or may include combinations of single and multiple sites. Further, components of this invention may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

What is claimed is:

1. A method, comprising:
storing a first user's folder in memory, the folder having files therein, the folder having different share levels for other users, the first user being self-registered;
receiving a request from a self-registered user over the Internet for a list of accessible folders shared to him/her;
determining if a folder is accessible to the self-registered user based on share levels;
transmitting a list of Shared folders to the self-registered user over the Internet if the folders are determined to be accessible;
wherein the shared folders are placed in a “Virtual Share Root” Folder, and presented in a similar folder (tree) structure as the “self-registered” user's own files/folder;
receiving a file from the self-registered user for storage in the folder or sending a file to the self-registered user for downloading to local.

2. The method of claim 1, further comprising:
receiving a request for one of the determined files from the self-registered user;
transmitting the requested file to the self-registered user over the Internet; and
receiving a modified version of the requested file for storage in the folder.

3. The method of claim 1, wherein the share access levels are set by the first user.

4. The method of claim 1, wherein the share access levels are set by the first user from an Internet Browser; and wherein folders can be shared to multiple people;

5. The method of claim 1, wherein the share access levels are set by the first user from a client application, or Windows Explorer;

6. The method of claim 1, wherein the first user's files are stored logically.

7. The method of claim 1, wherein the list of determined files is displayed on a self-registered user's desktop client application.

8. The method of claim 1, wherein the list of files is displayed on a self-registered user's web browser.

9. The method of claim 1, wherein the list of the first user's files/folders and files/folders shared to the first user are organized into the same folder (tree) structure, having the shared folders placed inside of a Virtual Share Root Folder.

10. The method of claim 1, wherein the list of files is displayed on a self-registered user's client via Windows Explorer in a folder that contains all this user's files and files shared to this user.

11. The method of claim 1, wherein the list of shared files is displayed on a self-registered user's Windows Explorer window, or a client application that enables easy drag-n-drop of files/folder between local storage and the online storage, between this user's own folders, or the folders shared from other users.

12. The method of claim 1, wherein the list of shared files is displayed on a self-registered user's Windows Explorer window, without affecting Windows Explorer's responsiveness even within a slow network environment by implementing multi-threading, progress bar and local caching of remote files and virtual folder implementation.

13. A computer readable medium having stored thereon instructions to cause a computer to execute a method, the method comprising:
storing a first user's files in memory; the files having different share levels for other users;
receiving a request from a self-registered user over the Internet for a list of accessible files;
determining which of the files are accessible to the self-registered user based on share levels; and
transmitting a list of the determined files to the self-registered user over the Internet.

14. A system, comprising:
means for storing a first user's files in memory; the files having different share levels for other users;
means for receiving a request from a self-registered user over the Internet for a list of accessible files;
means for determining which of the files are accessible to the self-registered user based on share levels; and
means for transmitting a list of the determined files to the self-registered user over the Internet.

15. A system, comprising:
a file system layer capable of storing a first user's files in memory; the files having different share levels for other users;
a UI module capable of receiving a request from a self-registered user over the Internet for a list of accessible files, capable of determining which of the files are accessible to the self-registered user based on share levels, and capable of transmitting a list of the determined files to the self-registered user over the Internet.

16. The system of claim 15, wherein the file system includes RDBMS managed user accounts and folder tree system, and wherein the UI module is further capable of receiving a request for one of the determined files from the self-registered user; and further comprising a FTP service integrated with the file system and capable of transmitting the requested files to the self-registered user over the Internet.

17. The system of claim 15, wherein
the file system layer is further capable of storing folder data corresponding to a folder with folder files therein, the folder having a folder share level;
wherein the UI module is further capable of determining if the self-registered user has access based on the folder share level; and
further comprising an FTP service capable of transmitting the folder data to the self-registered user based on the folder share level.

18. The system of claim 15, wherein the share levels are set by the first user.

19. The system of claim 15, wherein the first user's files are stored logically.

20. The system of claim 15, wherein the list of determined files is displayed on a self-registered user's client application.

21. The system of claim 15, wherein the list of determined files is displayed on a self-registered user's web browser.

22. The system of claim 15, wherein the list of determined files is displayed on a self-registered user's Windows Explorer window.
